(19) United States
(12) Patent Application Publication
(10) Pub. No.: US 2026/0369717 A1
(43) Pub. Date: Nov. 19, 2026

(54) Two-component potting for a rechargeable battery

(71) Applicant: Hilti Aktiengesellschaft, Schaan (LI)

(72) Inventors: Rory BRITZ, Starnberg (DE); Daniel SELTMANN, Türkheim (DE); Markus HARTMANN, Mauerstetten (DE); Klaus HAUSER, Schwabmünchen (DE); Robert STANGER, Kaufbeuren (DE); Mathias FRENZEL, Unterdießen (DE); Moses ENDER, Kaufering (DE)

(21) Appl. No.: 19/126,536

(22) PCT Filed: Oct. 20, 2023
(86) PCT No.: PCT/EP2023/079256

§ 371 Date: May 1, 2025

(30) Foreign Application Priority Data
Nov. 9, 2022 (EP) 22206379.4

(51) Int. Cl. H01M 10/613

(52) U.S. Cl. CPC H01M 10/613

(57) ABSTRACT

A rechargeable battery, in particular as a removable energy supply for a power tool, contains at least one energy storage element with a contact device, a control apparatus, a potting chamber, and a rechargeable battery interface for selectively connecting the rechargeable battery to a power tool or charging apparatus. At least a first and second potting material are contained in the potting chamber, wherein the first potting material has a higher thermal conductivity than the second potting material and the second potting material has a lower electrical conductivity than the first potting material, and wherein the second potting material covers at least a part of the contact device of the at least one energy storage element.

The present invention relates to a rechargeable battery, in particular as a removable energy supply for a power tool.

### BACKGROUND

Rechargeable batteries are widely known in the prior art as an energy supply for a power tool. These rechargeable batteries usually include a number of energy storage cells (also referred to as rechargeable battery cells), which serve and are designed to receive, store, and deliver electrical energy. The receiving of electrical energy into the energy storage cells can also be referred to as charging (or loading). The delivery of electrical energy from the energy storage cells can also be referred to as discharging.

For loading or charging with electrical energy, the rechargeable battery is usually connected to a charging apparatus (also called a charger). The charging apparatus conducts electrical energy in accordance with a predetermined charging setting (also called the charging mode) having defined parameters for the actual charging process at the individual energy storage cells of the rechargeable battery.

### SUMMARY OF THE INVENTION

In particular when the rechargeable battery is being used intensively, i.e. in the case of a high and rapid delivery of electrical energy, the energy storage elements of the rechargeable battery heat up to a critical value. In other words: the rechargeable battery can here be heated up undesirably to such an extent that even permanent damage cannot be excluded.

Conventional commercially available systems for cooling a rechargeable battery are, however, often complex and/or expensive.

It is an object of the present invention to solve the problem described above.

The present invention provides a rechargeable battery, in particular as a removable energy supply for a power tool, which contains at least one energy storage element with a contact device, a control apparatus, a potting chamber, and a rechargeable battery interface for selectively connecting the rechargeable battery to a power tool or charging apparatus.

According to the invention, it is provided that at least a first and second potting material is contained in the potting chamber, wherein the first potting material has a higher thermal conductivity than the second potting material and the second potting material has a lower electrical conductivity than the first potting material, and wherein the second potting material covers at least a part of the contact device of the at least one energy storage element.

According to an advantageous exemplary embodiment, it can be possible that the first potting material contains at least in part a thermally conductive epoxy resin adhesive.

The first potting material can furthermore contain at least in part a thermosetting polymer. The thermal conductivity can be produced by the addition of at least one thermally and/or electrically conductive filler.

According to a further advantageous exemplary embodiment, it can be possible that the second potting material contains at least in part an electrically non-conductive silicone, wherein the latter takes the form of a 1K or 2K silicone.

According to an advantageous exemplary embodiment, it can be possible that the first potting material fills at least 50% of the volume of the potting chamber.

According to a further advantageous exemplary embodiment, it can be possible that the first potting material fills less than 50% of the volume of the potting chamber.

According to an advantageous exemplary embodiment, it can be possible that the first potting material has a thermal conductivity of 0.75 to 1 W/(m*K). The first potting material can furthermore have a thermal conductivity of 3 to 10 W/(m*K).

According to a further advantageous exemplary embodiment, it can be possible that the first potting material is polyurethane-based and is preferably an elastomer.

According to an advantageous exemplary embodiment, it can be possible that the first potting material has a UL94 flammability rating of V0.

According to a further advantageous exemplary embodiment, it can be possible that the at least one energy storage element is based on lithium-ion or Li-polymer technology.

According to an advantageous exemplary embodiment, it can be possible that a no-load voltage is limited to 60 volts.

### BRIEF DESCRIPTION OF THE DRAWINGS

Further advantages can be found in the following description of the Figures. A particularly preferred exemplary embodiment of the present invention is illustrated in the Figures. The Figures, the description, and the claims comprise numerous features in combination. A person skilled in the art will expediently also consider the features individually and combine them to form sensible further combinations.

Identical and similar components are denoted by the same reference signs in the Figures,
in which:

FIG. 1 shows a side view of a power tool and a rechargeable battery according to the invention;

FIG. 2 shows a lateral view in section of the rechargeable battery according to the invention;

FIG. 3 shows a view in section of the rechargeable battery along the plane of section A-A from FIG. 2; and

FIG. 4 shows a view in section of the rechargeable battery along the plane of section B-B from FIG. 2.

### DETAILED DESCRIPTION

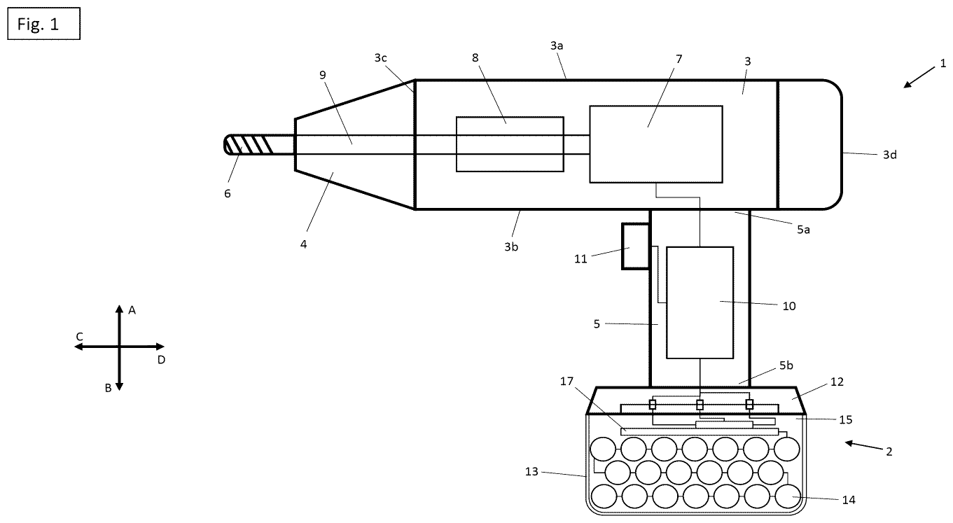

FIG. 1 shows a power tool 1 and a rechargeable battery 2 according to an exemplary embodiment. The rechargeable battery 2 is removably connected to the power tool 1 in order to supply the power tool 1 with electrical energy.

The power tool 1 is configured as a power drill in the embodiment shown. Alternatively, the power tool 1 can also be configured as a screwdriver, a hammer drill, a saw, a grinder, or the like.

As indicated in FIG. 1, the power tool 1 configured as a power drill substantially contains a power tool housing 3 with a tool fitting 4 and a handle 5.

The tool fitting 4 serves to receive and retain a tool 6.

The tool 6 is a drill bit in the present exemplary embodiment. Alternatively, the tool 6 can also be configured as a screwdriver bit.

A drive 7, a transmission 8, an output shaft 9, and a control unit 10 are, inter alia, provided in the interior of the power tool housing 3.

The drive 7 is configured, for example, as a brushless electric motor and serves to generate torque.

The control unit 10 controls in a closed and open loop the functions and the behavior of the power tool 1 and in particular the drive 7, i.e. the direction of rotation and speed of the drive 7.

The handle 5 in turn includes an actuating switch 11, an upper end 5a, and a lower end 5b. The actuating switch 5 is connected to the control unit 10 such that actuating the actuating switch 11 results in an activation of the drive 7 or the power tool 1.

As also shown in FIG. 1, the drive 7, the transmission 8, the output shaft 9, and the tool fitting 4 are arranged relative to one another such that torque generated by the drive 7 can be transmitted to the tool fitting 4 via the transmission 8 and the output shaft 9. The torque generated by the drive is ultimately transmitted to the tool 6 by the tool fitting 4.

The power tool housing 3 furthermore has an upper side 3a, a lower side 3b, a front end 3c, and a rear end 3d.

The tool fitting is positioned at the front end. The upper end 5a of the handle 5 is fastened to the lower side 3b and in the vicinity of the rear end 3d of the power tool housing 3. A power tool interface 12 is positioned at the lower end 5b of the handle 5. The power tool interface 12 is used for removably connecting the power tool 1 to the rechargeable battery 2.

According to an alternative exemplary embodiment (not shown in the Figures), the power tool 1 can also be configured such that it is connected to more than one rechargeable battery 2 as an energy source.

The rechargeable battery 2 described in the exemplary embodiment can be used in particular as an energy storage apparatus or electrical energy source for the power tool 1. The rechargeable battery 2 here substantially contains a rechargeable battery housing 13, a number of energy storage cells 14, a rechargeable battery interface 15, a potting chamber 16, and a control device 17.

The energy storage cells 14 can also be referred to as rechargeable cells.

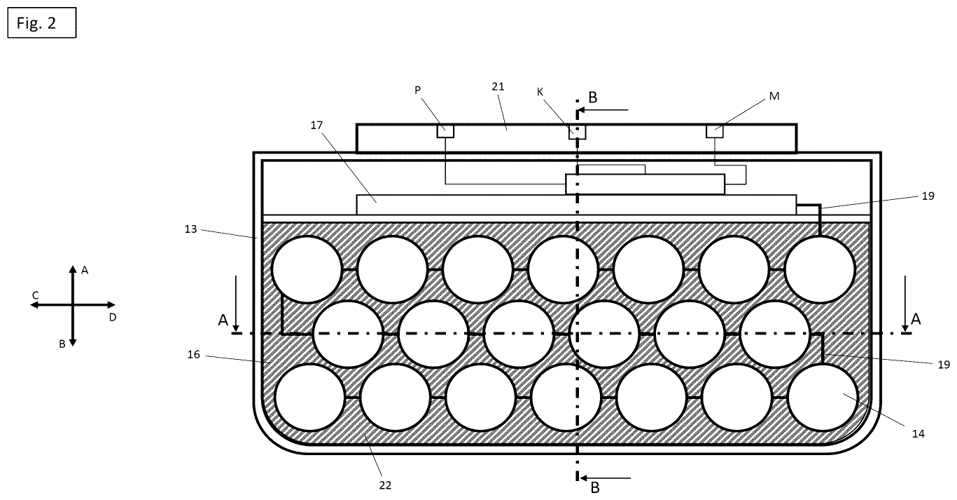

The rechargeable battery interface 15 serves to electrically or electronically connect the rechargeable battery 2 to the power tool 1 by means of the power tool interface 12. For this purpose, the rechargeable battery interface 15 includes a positive contact P, a negative contact M, and a communication contact K (see, e.g, FIG. 2). The positive contact P and negative contact M serve to transmit electrical energy from the energy storage cells 14 of the rechargeable battery 2 to the consumers (in particular the drive 7) of the power tool 1.

The communication contact K in turn serves to communicate between the control device 17 of the rechargeable battery 2 and the control unit 10 of the power tool 1. For the communication between the rechargeable battery 2 and the power tool 1, data and information are exchanged in the form of signals.

The energy storage cells 14 serve to receive, store, and re-deliver electrical energy. As indicated in the Figures, the energy storage cells 14 are cylindrical and configured on the basis of lithium-ion technology. As indicated in the Figures, each energy storage cell 14 contains at one end a contact device 18 which serves to transmit electrical energy. As also shown in the Figures, the individual contact devices 18 are connected to the control device 17 via corresponding lines 19.

Alternatively, the energy storage cells 14 can also be based on another suitable technology.

The cylindrical shape of the energy storage cells 14 is likewise optional such that any other suitable shape or geometry can also be selected. It is thus in particular also possible that the energy storage cells 14 are configured as pouch cells.

It is additionally also possible that the rechargeable battery 2 contains both cylindrical energy storage cells and pouch cells. It is in particular possible that the rechargeable battery 2 contains a single cylindrical energy storage cell and a single pouch cell.

The control device 17 controls the different functions of the rechargeable battery 2 in a closed-loop and open-loop manner. In addition, the control device 17 is connected to the energy storage cells 14 and the rechargeable battery interface 15 via corresponding lines 20 such that electrical energy can pass from the energy storage cells 14 via the control device 17 to the rechargeable battery interface 15.

To removably mechanically couple the rechargeable battery 2 to the power tool 1, the system consisting of a power tool 1 and a rechargeable battery 2 contains a rail apparatus 21. As indicated in the Figures, the rail apparatus 21 is positioned between the rechargeable battery interface 15 and the power tool interface 12 such that the rechargeable battery 2 can be slid along the rail apparatus 21 and onto the power tool 1 in the direction of arrow C and removed (slid off) from the power tool 1 again in the direction of arrow D. If the rechargeable battery 2 is coupled to the power tool 1 with the aid of the rail apparatus 21, the positive contact P, the negative contact M, and the communication contact K of the rechargeable battery 2 are in contact with the corresponding positive and negative contacts P, M and the communication contact K of the power tool 1. Electrical energy and electrical signals can then pass from the rechargeable battery 2 to the power tool 1.

A locking apparatus is used to removably connect the rechargeable battery 2 to the power tool 1.

The potting chamber 16 is configured substantially as a tray with a cavity 22. The energy storage cells 14 are positioned in the cavity 22.

The potting chamber 16 is furthermore configured such that liquid potting material can be introduced and is retained.

A first potting material VM1 and a second potting material VM2 are poured into the rechargeable battery 2 according to a first exemplary embodiment around a plurality of energy storage elements 14.

The first potting material VM1 here has a higher thermal conductivity than the second potting material VM2.

According to the first exemplary embodiment, the thermal conductivity of the first potting material VM1 is 0.8 W/(m*K).

The thermal conductivity of the second potting material VM2 is in contrast 0.2 W/(m*K).

Alternatively, the thermal conductivity of the first potting material VM1 can be 0.75 to 1 W/(m*K). The value of the thermal conductivity of the second potting material VM2 is here essentially half the value of the thermal conductivity of the first potting material VM1. Alternatively, the value of the thermal conductivity of the second potting material VM2 can be just a quarter (=¼) of the value of the thermal conductivity of the first potting material VM1.

In addition, the second potting material VM2 has a lower electrical conductivity (specific electrical resistance, i.e. at least 10¹⁰ Ωcm) than the first potting material VM1. The value of the electrical conductivity of the first potting material VM1 is here at least twice as large as the value of the electrical conductivity of the second potting material VM2.

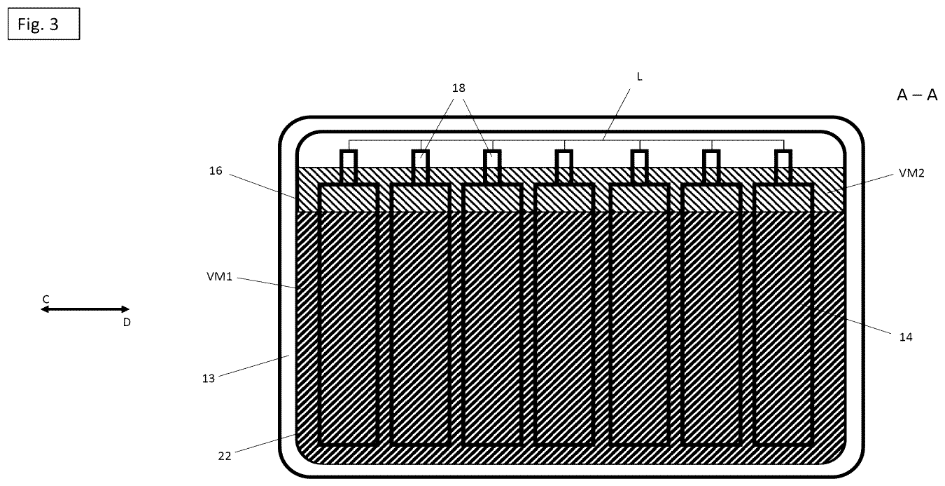

As indicated in particular in FIGS. 2 and 3, the potting chamber 16 is not filled with the same proportions by volume of the first and second potting material VM1, VM2. According to the first exemplary embodiment, the first potting compound VM1 fills approximately 70% of the volume of the potting chamber 16. The second potting material VM2, in contrast, fills approximately 20% of the volume of the potting chamber 16. The remaining 10% of the volume of the potting chamber 16 is filled with air. The first and second potting material VM1, VM2 are positioned in the potting chamber 16 such that the second potting material VM2 encases an upper part of the energy storage cells 14 with the respective contact device 18. A part of the contact device 18 thus remains free of the second potting material VM2 such that in each case a line 20 leads from a free (uncovered) end of the contact device 18 to the control device 17.

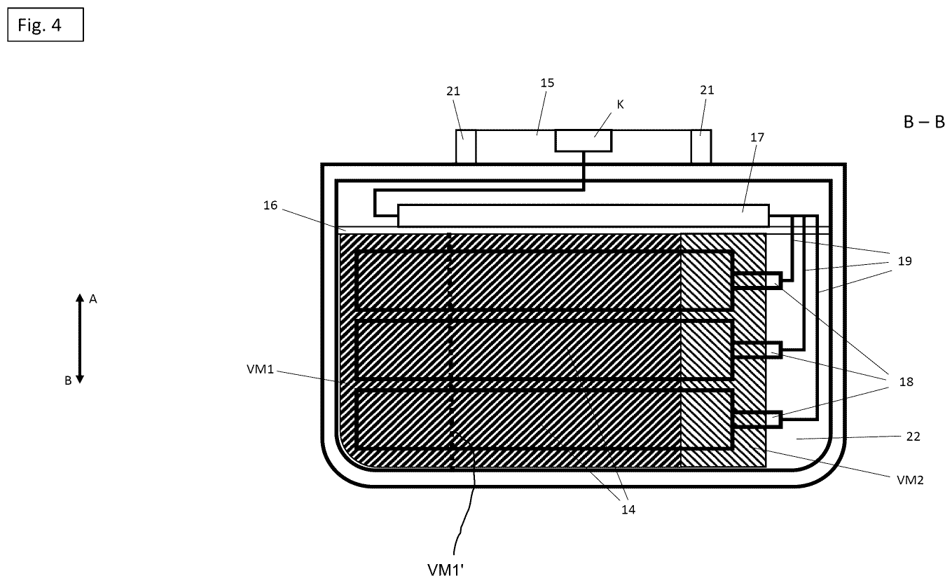

Alternatively, the first potting material can fill 70% of the volume of the potting chamber 16 and the second potting material VM2 can fill 30% of the volume of the potting chamber 16 such that there is no longer any volume of the potting chamber 16 which is filled with air. As shown schematically by FIG. 4 line VM1′ the first potting material can be less than 50% of the volume

Almost optimal heat dissipation from the energy storage cells 14 is ensured by the relatively high proportion of the second potting material VM2.

### LIST OF REFERENCE SIGNS

1 power tool
2 rechargeable battery
3 power tool housing
3a upper side of the power tool housing
3b lower side of the power tool housing
3c front end of the power tool housing
3d rear end of the power tool housing
4 tool fitting
5 handle
5a upper end of the handle
5b lower end of the handle
6 tool
7 drive
8 transmission
9 output shaft
10 control unit
11 actuating switch
12 power tool interface
13 rechargeable battery housing
14 energy storage cells
15 rechargeable battery interface
16 potting chamber
17 control device
18 contact device
19, 20 line
21 rail apparatus
22 cavity
P positive contact
M negative contact
K communication contact
VM1 first potting material
VM2 second potting material

What is claimed is:

1 to 10. (canceled)

11. A rechargeable battery comprising:
at least one energy storage element having a contact;
a controller;
a potting chamber;
a rechargeable battery interface for selectively connecting the rechargeable battery to a power tool or charging apparatus; and
a first potting material and a second potting material contained in the potting chamber. the first potting material having a higher thermal conductivity than the second potting material and the second potting material having a lower electrical conductivity than the first potting material, the second potting material covering at least a part of the contact of the at least one energy storage element.

12. The rechargeable battery as recited in claim 11 wherein the first potting material includes a thermally conductive epoxy resin adhesive.

13. The rechargeable battery as recited in claim 11 wherein the second potting material includes an electrically non-conductive 1K or 2K.

14. The rechargeable battery as recited in claim 11 wherein the first potting material fills at least 50% of a volume of the potting chamber.

15. The rechargeable battery as recited in claim 11 wherein the first potting material fills less than 50% of the volume of the potting chamber (16).

16. The rechargeable battery as recited in claim 11 wherein the first potting material has a thermal conductivity of 0.75 to 1 W/(m*K).

17. The rechargeable battery as recited in claim 11 wherein the first potting material is polyurethane-based.

18. The rechargeable battery as recited in claim 17 wherein the first potting material is an elastomer.

19. The rechargeable battery as recited in claim 11 wherein the first potting material has a UL94 flammability rating of V0.

20. The rechargeable battery as recited in claim 11 wherein the at least one energy storage element is based on lithium-ion or Li-polymer technology.

21. The rechargeable battery as recited in claim 11 wherein a no-load voltage is limited to 60 volts.

22. The rechargeable battery as recited in claim 11 wherein the rechargeable battery is a removable energy supply for a power tool.
